(19) United States
(12) Patent Application Publication
(10) Pub. No.: US 2011/0097073 A1
(43) Pub. Date: Apr. 28, 2011

(54) CAMERA MODULE

(75) Inventors: Chai-Wei Lee, Tu-Cheng (TW); Hou-Yao Lin, Tu-Cheng (TW); Sheng-Jung Yu, Tu-Cheng (TW)

(73) Assignee: HON HAI PRECISION INDUSTRY CO., LTD., Tu-Cheng (TW)

(21) Appl. No.: 12/758,773

(22) Filed: Apr. 12, 2010

(30) Foreign Application Priority Data
Oct. 23, 2009 (CN) 200910308681.7

(51) Int. Cl. G03B 17/00

(52) U.S. Cl. 396/533

(57) ABSTRACT

A camera module includes a lens barrel, a lens holder, and a resilient member. The lens barrel includes a first body and an extending part, and a first step surface formed between the first body and the extending part. The lens holder includes a second body, a shielding annular protrusion extends inwardly from the second body, the shielding annular includes a second step surface. The resilient member is compressed and interposed between the first step surface and the second step surface.

### BACKGROUND

1. Technical Field

The present disclosure relates to a camera module.

2. Description of Related Art

Most camera modules providing focus function include a lens holder meshed with a lens barrel via threading. When focusing, the lens barrel is screwed back and forth to find the focus. However, friction force of such action is often not uniform reducing stability of focus.

Therefore, it is desirable to provide a camera module which can overcome the limitations described.

### BRIEF DESCRIPTION OF THE DRAWINGS

FIG. 1 is an isometric and exploded view of a camera module, according to an exemplary embodiment.

FIG. 2 is an isometric and exploded view of the camera module of FIG. 1, viewed at another angle.

FIG. 3 is an assembled view of the camera module of FIG. 1.

FIG. 4 is a cross-section taken along a line IV-IV of FIG. 3.

### DETAILED DESCRIPTION

Embodiments of the disclosure are now described in detail with reference to the drawings.

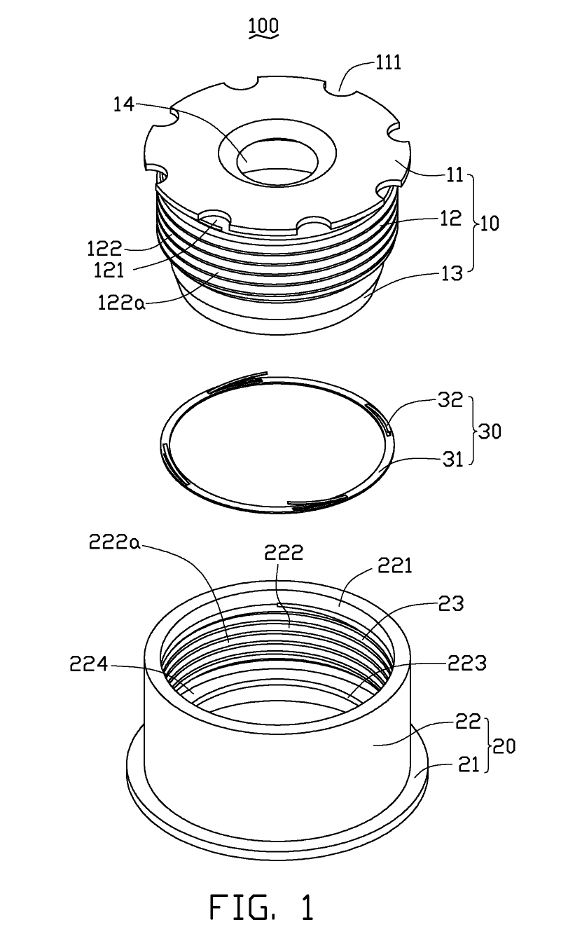

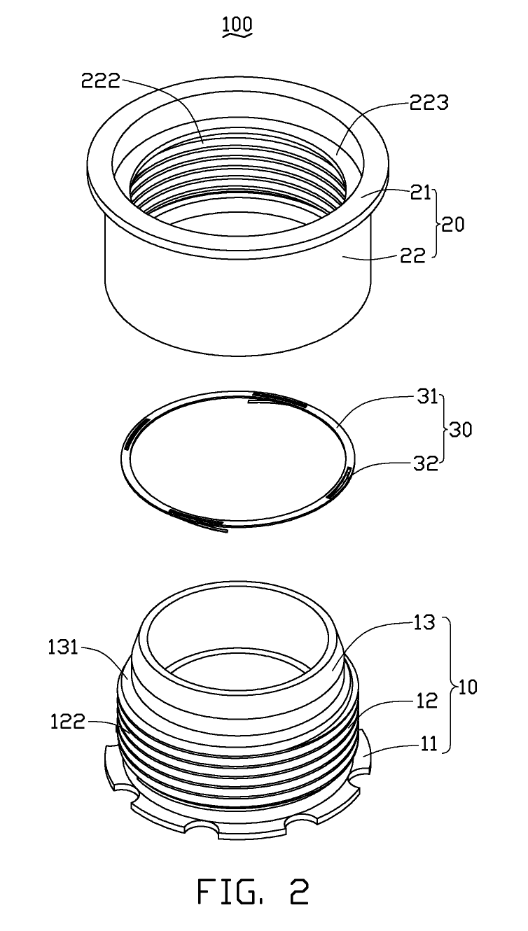

Referring to the FIGS. 1-2, a camera module 100, according to an exemplary embodiment, includes a lens barrel 10, a lens holder 20, and a resilient member 30. The lens barrel 10 is partially received in the lens holder 20, and the resilient member 30 is compressed and interposed between the lens barrel 10 and the lens holder 20.

The lens barrel 10 includes a focusing ring 11, an extending part 13, and a first body 12 connected between the focusing ring 11 and the extending part 13. An aperture 14 is defined through the center of the focusing ring 11 and communicates with the interior of the lens barrel 10 to allow light to pass through the lens barrel 10. One or more lenses are received in the first body 12.

The focusing ring 11 defines a number of operation cutouts 111 in the outer circumferential surface thereof. The operation cutouts 111 are equidistantly arranged around the circumference of the focusing ring 11, for facilitating manual rotation thereof.

The first body 12 is cylindrical, and includes an outer surface 121. The first body 12 defines an external threaded section 122 on the outer surface 121. The external threaded section 122 includes three external threads 122a, pitched equidistantly. The outer diameter of the external threaded section 122 is less than that of the focusing ring 11.

The extending part 13 is cylindrical, with an outer diameter less than that of the first body 12. As such, a first step surface 131 is formed between the extending part 13 and the first body 12 and faces the extending part 13.

The lens holder 20 includes a fixing plate 21 and a second body 22 formed on the fixing plate 21. A receiving hole 23 runs substantially through the center of the fixing plate 21 and the second body 22. The receiving hole 23 is configured for receiving the lens barrel 10.

The fixing plate 21 is annular and can be mounted on a base plate (not shown) to which the camera module 100 is mounted. The outer diameter of the fixing plate 21 exceeds that of the second body 12.

The second body 22 is cylindrical, and includes an inner surface 221. The second body 22 includes an internal threaded section 222 formed on the inner surface 221. The internal threaded section 222 includes three internal threads 222a, pitched equidistantly. The pitches of the internal threads 222a exceed the thicknesses of the external threads 122a. As such, the external threaded section 122 and the internal threaded section 222 can loosely mesh with each other. The second body 22 extends inward a shielding annular protrusion 223 from the inner surface 221. The shielding annular protrusion 223 is located between the internal thread 222 and the fixing plate 21. The inner diameter of the shielding annular protrusion 223 is less than that of the second body 12. As such, the shielding annular protrusion 223 forms a second step surface 224 facing the internal threaded section 222. The inner diameter of the shielding annular protrusion 223 exceeds the outer diameter of the extending part 13 and is less than the outer diameter of the external threaded section 122.

It is noteworthy that the number of external threads 122a and internal threads 222a are not limited to those disclosed. In order to improve focus range, more external threads 122a and internal threads 222a can respectively be defined on the outer surface 121 and inner surface 221.

It should be understood that, the pitches of the external threads 122a can exceed the thicknesses of the internal threads 222a. As such, the external threaded section 122 and the internal threaded section 222 can also loosely mesh with each other.

The resilient member 30 has an annular configuration, and is made of resilient materials (i.e., iron). The resilient member 30 includes a ring-shaped plate 31 and a number of spring arms 32 stamped out from the ring-shaped plate 31 and extending upward from the plate 31. The spring arms 32 are curved, and extend clockwise. In the embodiment, the resilient member 30 includes four spring arms 32 equidistantly arranged on the ring-shaped plate 31.

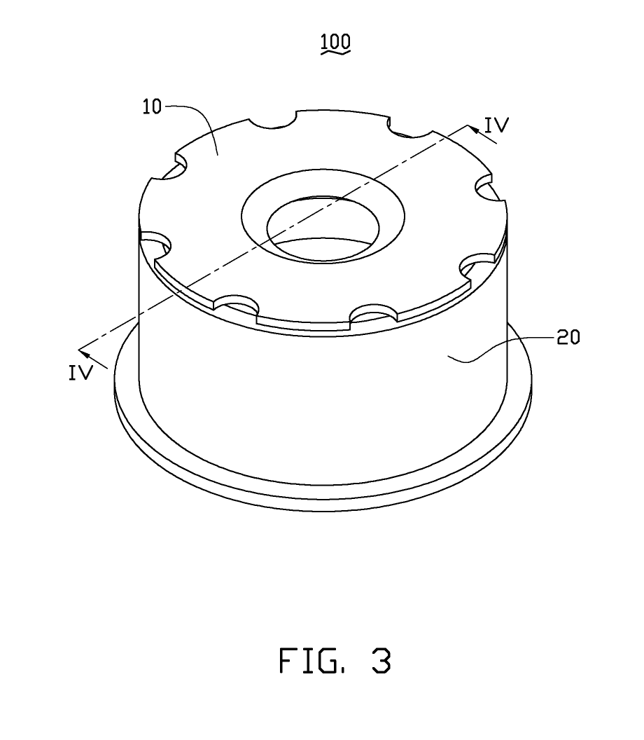

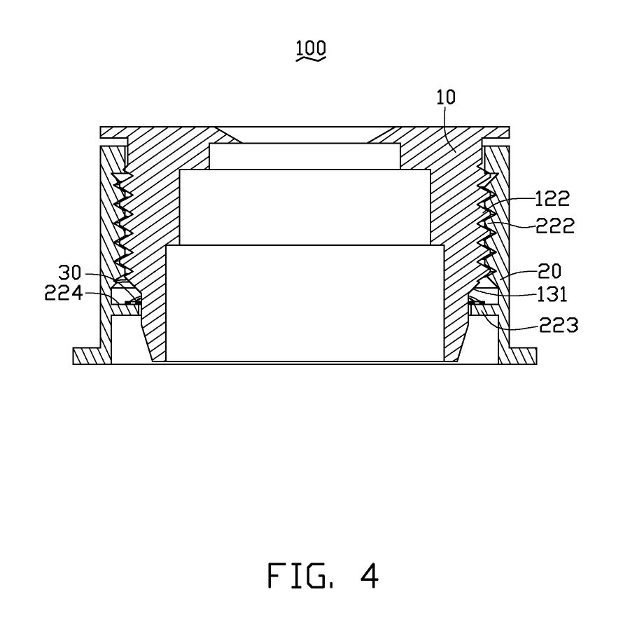

Referring to the FIGS. 3-4, during assembly, the resilient member 30 is placed on the shielding annular protrusion 223 of the lens holder 20 and the ring-shaped plate 31 abuts the second step surface 224. The lens barrel 10 is received in the second receiving hole 23, and the external threaded section 122 of the lens barrel 10 screws and meshes with the internal threaded section 222 of the lens holder 20. The extending part 13 extends through the shielding annular protrusion 223. The focusing ring 11 of the lens barrel 10 is not yet rotated by the user until the spring arms 32 of the resilient member 30 abut the first step surface 131.

In operation, the external threaded section 122 meshes with the internal threaded section 222 under the resilient force generated between the first step surface 131 and the second step surface 224. When the camera module 100 is to be focused, a spring force impels the focusing ring 11 toward the lens holder 20. The resilient member 30 is compressed and moves the internal threads 222a out of mesh with the external threads 122a. Then a torsional force is exerted on the focusing ring 11 while maintaining the spring force, and the lens barrel 10 can be stably screwed back and forth to locate focus without friction.

It is noteworthy that as the inner diameter of the shielding annular protrusion 223 is less than the outer diameter of the external threaded section 122 and exceeds the outer diameter of the inner surface 221, abrasion from the external threads 122a and the internal threads 222a can be shielded by the shielding annular protrusion 223.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A camera module, comprising:
a lens barrel comprising a first body and an extending part, and a first step surface formed between the first body and the extending part, the outer diameter of the extending part less than that of the first body; wherein the first body comprises an external threaded section on an outer surface thereof;
a lens holder comprising a second body, and defining a receiving hole therethrough;
wherein the second body comprises an inner surface, and an internal threaded section on the inner surface; a shielding annular protrusion extends inwardly from the second body, the shielding annular includes a second step surface; the lens barrel is received in the receiving hole, the external threaded section of the lens barrel loosely meshes with the internal threaded section of the lens holder; and the extending part extends through from the shielding annular protrusion; and
a resilient member compressed and interposed between the first step surface and the second step surface.

2. The camera module in claim 1, wherein the pitches of the internal threaded section exceed the thicknesses of the external threaded section.

3. The camera module in claim 1, wherein the pitches of the external threaded section exceed the thicknesses of the internal threaded section.

4. The camera module in claim 1, wherein the resilient member comprises a ring-shaped plate and a plurality of spring arms stamped out and extending upward from the ring-shaped plate.

5. The camera module in claim 4, wherein the spring arms are curved, and extend along clockwise on the ring-shaped plate.

6. The camera module in claim 5, wherein the resilient member is comprised of metallic material

7. The camera module in claim 1, wherein the inner diameter of the shielding annular protrusion exceeds the outer diameter of the extending part and is less than the outer diameter of the external threaded section.

8. The camera module in claim 1, wherein the lens barrel further comprises a focusing ring, the first body is interconnected between the focusing ring and the extending part; and the focusing ring defines a plurality of operation cutouts in the outer circumferential surface thereof.

9. The camera module in claim 1, wherein the lens holder further comprises a fixing plate on which the second body is formed; and the shielding annular protrusion is located between the internal threaded section and the fixing plate.
